(19) United States
(12) Patent Application Publication
(10) Pub. No.: US 2024/0167539 A1
(43) Pub. Date: May 23, 2024

(54) Chain And Arrangement Of A Chain With A Sprocket

(71) Applicant: J.D. Theile GmbH & Co. KG, Schwerte (DE)

(72) Inventors: Ivan Kresic, Schwerte (DE); Dirk Mag, Schwerte (DE)

(21) Appl. No.: 18/516,114

(22) Filed: Nov. 21, 2023

(30) Foreign Application Priority Data
Nov. 22, 2022 (DE) 20 2022 106 526.8

(51) Int. Cl. F16G 15/12; F16G 13/18

(52) U.S. Cl. CPC F16G 15/12; F16G 13/18

(57) ABSTRACT

A chain having a chain link with two legs and two bows connecting the legs together, the bows extending in the bow extension direction between the two legs, wherein an end face of at least one bow, which faces outwards in the pitch direction of the chain link, has two pressure portions spaced apart from one another in the bow extension direction and an intermediate portion connecting the pressure portions, wherein the pressure portions each provide a contact surface between the chain link and a corresponding chain pocket of a chain wheel for introducing a force into the chain, and wherein the end face of the bow is convexly curved in the bow extension direction in the pressure portions and the end face of the bow has, at least in portions in the intermediate portion, a smaller radius of curvature than in the pressure portions.

### RELATED APPLICATION

This application claims priority to German application DE 202022106526.8 filed Nov. 22, 2022, which is fully incorporated-by-reference herein.

### BACKGROUND

A chain includes a large number of chain links that are hooked together. The chain links have two opposite, usually parallel, legs and bows connecting the two legs, so that a closed course is formed by each chain link. These are usually steel chains.

A chain can be used for several applications. Chains are subjected to tension and are used, for example, to tension objects or are used as a drive in a conveyor. Two parallel chains are usually arranged in a conveyor, wherein webs are provided between the two chains, which push and thus move a material lying on a path, for example a conveyor trough. Chains thus used are endless chains; the chains are diverted at the ends of the track.

To introduce a tensile force onto the chain, a chain wheel is used which has at least one chain pocket. The chain pocket is designed to correspond to a first chain link of the chain, so that there is positive contact in the pulling direction between the chain link and the chain pocket. This contact moves the chain link in the pulling direction, so that a pulling force acts on the chain. This first chain link is usually the horizontal chain link of a chain formed by horizontal and vertical chain links, such as is common for conveyors.

The positive contact between the chain pocket and the chain link usually takes place in the bow region, namely in the outward-facing region of the end face of the bow facing in the pitch direction (longitudinal extension direction of the chain link). The force is transferred from the chain pocket to the chain link by means of a compressive force introduced into the chain link by the chain pocket.

A known design of such a chain link is addressed in DE 19610935 A1, DE 19831994 and DE 4124788 A1. The type of chain mentioned in these disclosures is also called an arrow tooth chain. The bow of an arrow tooth chain link is designed in such a way that it is divided into three parts along its direction of extension with which it connects the two legs: two pressure portions spaced apart from one another in the bow extension—thus essentially in the chain link width direction—and an intermediate portion in between that connects the pressure portions. The pressure portions of the chain link serve as contact surfaces between the chain link and the chain pocket for transmitting the driving forces and can therefore also be indicated as output surfaces.

The aim of the arrow tooth chains mentioned is to provide the pressure portions straight, at least in the bow extension direction, in order to achieve a large surface contact between the chain pocket and the horizontal chain link as an already constructed contact surface and thus to keep the surface pressure in this region low.

For self-centering, the pressure portions are arranged in an arrow shape relative to the chain link width direction, so that the intermediate portion is curved at least in portions.

The problem with these arrow tooth chains is that the desired designed large-region contact is not achieved during operation due to local load-related deformations. Rather, such chains tend to ride at the edges of the pressure portions, which results in excessive wear of the chain link and the chain pocket, usually resulting in a duck tail.

The foregoing examples of related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools, and methods which are meant to be illustrative and not limiting in scope. In various embodiments, one or more problems have been reduced or eliminated, while other embodiments are directed to other improvements.

Proceeding from this background, one aspect of the present disclosure is to develop a chain which enables safe and durable operation in practice even under load. Another aspect is to provide an arrangement of such a chain and a chain wheel or sprocket.

Such a chain may comprise a chain link with two legs and two bows connecting the legs together, the bows extending in the bow extension direction between the two legs, wherein an end face of at least one bow, which faces outwards in the pitch direction of the chain link, has two pressure portions spaced apart from one another in the bow extension direction and an intermediate portion connecting the pressure portions, wherein the pressure portions each provide a contact surface between the chain link and a corresponding chain pocket of a chain wheel for introducing a force into the chain, and wherein the end face of the bow is convexly curved in the bow extension direction in the pressure portions and the end face of the bow has, at least in portions in the intermediate portion, a smaller radius of curvature than in the pressure portions.

The end face of at least one bow, typically both bows, in the pressure portions is designed to be convexly curved in the direction of the bow extension. As a result, the contact surface is designed as a point load. However, due to the flattening deformation of the pressure portion in the chain pocket due to the point load during operation, the actual contact area is increased compared to the unloaded state; the deformation increases the radius of curvature of the pressure portions. The higher the load on the chain, the more the pressure portion deforms and in this way offers a larger contact area, which in turn reduces the surface pressure. The pressure portion therefore provides an adaptive contact surface depending on the load and is no longer a complete contact surface from a design perspective. Rather, normally only part of the pressure portion is a contact surface.

In order to provide an optimal load-dependent contact surface size and at the same time keep the local surface pressure at an acceptable level, the radius of curvature of the pressure portions is provided particularly large in the direction of the bow extension. The calculation of an optimal curvature takes into account the assumed load amplitude, the size of the chain link or the chain pocket, particularly in the bow extension direction, and the deformation behavior of the chain link and the chain pocket, which depends in particular on the material used, which is usually steel. The curvature in the pressure portion can essentially correspond to a radius of 1.5 times to 10 times, preferably 1.6 times to 8 times, the outer width of the chain link.

In the region in which there is a positive connection between the pressure portion and the chain pocket, the associated, corresponding chain pocket also has a pressure portion (hereinafter referred to as the drive portion), which is provided with a complementary, usually concave curvature which is smaller than the curvature of the pressure portion. The radius of curvature is therefore larger; the chain pocket-side drive portion, which interacts with the pressure portion of the chain link, can also be designed as a straight line in the bow extension direction. This enables the chain link to be inserted into the chain pocket.

By providing a curvature in the pressure portions, edge riding is prevented, since even if the chain link in the chain pocket is not optimally aligned around the vertical axis of the chain link, a large contact surface is always provided, which adapts variably in terms of its position along the pressure portion. Since the respective pressure portion has a larger extension in the bow extension than the respective contact surface provided during design, the pressure portion around the intended contact surface provides a kind of buffer region for the edges, in which in practice the contact surface can actually be provided without the risk of edge wear. The ideal, theoretical contact surface is therefore not limited by edges. The contact surface on the pressure portion is therefore already constructively adapted to different positions of the chain link and load levels.

Against this background, it is also preferred to provide a constant radius of curvature in the pressure portion; the pressure portion is then provided with a uniform radius in the bow extension direction. This always ensures the same behavior in terms of the resulting size of the contact surface, regardless of whether the chain link is ideally aligned in the chain pocket or slightly displaced around its vertical axis, which can be viewed as a tolerable misalignment.

In order to provide pressure portions that are separated from each other, approximately symmetrically opposite one another, the intermediate portion has, at least in portions, a greater curvature, and therefore a smaller radius of curvature, than the pressure portions. Usually, the radius of curvature of the pressure portions is so large that it is not possible in practice to continue the end face with the same curvature of the pressure portions. The corresponding curvature of the intermediate portion can also be convex, but also concave. Then the intermediate portion is set back relative to the contact surfaces of the pressure portions. Provision can also be made to provide chain links with straight bow end faces with convex pressure portions and an intermediate portion in between in order to obtain the advantages according to the disclosure. The design of the intermediate portion, including its transitions to the pressure portions (which are assigned to the intermediate portion), thus influences the position of the pressure portions relative to the width direction of the chain link. The intermediate portion can have a constant radius of curvature; it is also possible for it to merge into the pressure portions in a bent or semi-bent manner on its sides facing the two pressure portions. Then in the region of the bend it usually has a much smaller radius of curvature than the pressure portions. It is also possible for the intermediate portion to have the aforementioned, approximately constant curvature only in portions, wherein straight portions that extend up to the pressure portions are adjacent on both sides. These straight portions are preferably tangents of the two curved portions connected by the straight portions.

The pressure portions are usually symmetrical to one another with respect to the pitch axis of the chain link.

It is preferably provided that the mean tangent of the curvature in the bow extension direction of each pressure portion forms an angle of 7° to 20°, preferably up to 15°, with the chain link width direction. The mean tangent is the mean of the tangents of the end face of the possible contact surfaces in the pressure portion. The minimum dimension of this angle is preferably determined by the arctan (u), where u is the coefficient of friction of the chain link and the corresponding chain pocket in the contact region. In this way, self-centering of the chain link in the chain pocket is simplified because the self-locking caused by friction is overcome. However, a larger angle worsens the direction of force introduction into the chain link, which is preferably aligned as parallel as possible to the legs. Against this background, it is preferably provided to further limit the angle mentioned to 15°, preferably to 12°.

Furthermore, it can be provided that the pressure portion and also usually the intermediate portion are convexly curved transversely to the extension of the bow. The end face of the bow is therefore curved in the height direction; overall, the aim is to achieve an elliptical dome-like design of the pressure portions due to the curvatures in and transverse to the bow extension direction. The radius of curvature transverse to the bow extension can preferably be the same for the pressure portion and the intermediate portion. The aim of this convex curvature is also to create a theoretical point load in the respective contact surface with a view to the chain pocket, which increases in accordance with the load due to deformation and also to provide a tolerance for a potential misalignment around the transverse axis of the chain link. For this purpose, the radius of curvature of the chain pocket, which is usually convex, is larger than that of the chain link and can also be designed to be straight.

Typically, the curvature transverse to the bow extension is significantly larger than in the bow extension and can be approximately half the height of the chain link. The location of the contact surface in the height direction is usually at a position relative to the curvature transverse to the bow extension, in which the tangent of the curvature transverse to the bow extension forms an angle of <arctan(μ) with the height direction and thus essentially perpendicular to the pulling direction of the chain, where u is the coefficient of friction of the chain link and the chain pocket in the region of the contact surface. This angle is approximately 7°. Against this background, it is preferably proposed to design the chain pocket in such a way that the contact surface extends at least into the region of the equator line of the chain link.

It is preferably provided that the bow is designed to be rounded overall. Such a bow can also be described as edge-less. It preferably has convex curvatures in all directions and has no corners or incising or undercutting pockets. In this way, material sticking is prevented. It goes without saying that the entire chain link is preferably designed to be rounded overall.

It is preferably provided that the position of the contact surfaces in the width direction of the chain link is limited to the alignment of the legs in normal operation. These are therefore in alignment with the envelope formed by the lateral surface of the respective adjoining legs. In this way, a particularly advantageous introduction of force into the chain link is made possible. An offset transverse to the longitudinal extent of the leg between the contact surface and the central fiber of the leg is usually acceptable, although introduction into the central fiber is preferred. By accumulating material in the transition from the bow to the leg, so that the cross section of the chain link in the transition region is larger than the leg diameter, the force introduced into the legs is evened out.

It is usually intended to provide the pressure portions of the bow up to the outer width of the chain link.

In this context, it can also be provided that the chain has kink protection. A kink occurs when the second chain link engaging in the first chain link encloses a leg of the first chain link and dips into the inner width of the first chain link. It can then happen that the second chain link gets stuck in an incorrect position relative to the first chain link. Many different designs may be used to prevent this.

For example, it can be provided that the legs of the first chain link are D-shaped in cross section, so that a stop is provided at the edges of the D. The edges of the D prevent the second chain link from diving into the first chain link. This is usually achieved in that, due to the D-shape, the diameter transverse to the diving direction of the second chain link is locally so large that the second chain link cannot be aligned in accordance with the diving direction relative to the first chain link. In this way, a kinking situation is prevented.

In another embodiment, self-unkinking can also be provided as protection against kinks. This is described in U.S. application Ser. No. 18/515,810 filed Nov. 21, 2023 from the same applicant. In particular, it describes a functional portion that is arranged in the bow region. The functional portion provides an extension in the bow extension, via which a force can be introduced into the end face of the chain link. Reference is made in full to the relevant statements and designs in U.S. application Ser. No. 18/515,810, which is incorporated-by-reference herein.

In addition to aspects and embodiments described above, further aspects and embodiments will become apparent by reference to the drawings, wherein like reference numerals generally designate corresponding structures in the several views.

### BRIEF DESCRIPTION OF THE DRAWINGS

The below descriptions are provided with reference to the figures, wherein:

FIG. 1 shows a perspective view of a first chain link,

FIG. 2 shows a top view of a first chain link in a schematically indicated chain pocket, with cross sections A-A, B-B, and C-C taken along lines A-A, B-B, and C-C, respectively,

FIGS. 3a, 3b, and 3c show a front view of the bow end face with marked contact surfaces at different load levels, and

FIG. 4 shows a perspective view of an example chain.

It is to be understood that the invention is not limited in application to the details of particular arrangements shown in the drawings, since the invention is capable of other embodiments. Embodiments and figures disclosed herein are to be considered illustrative rather than limiting.

### DETAILED DESCRIPTION

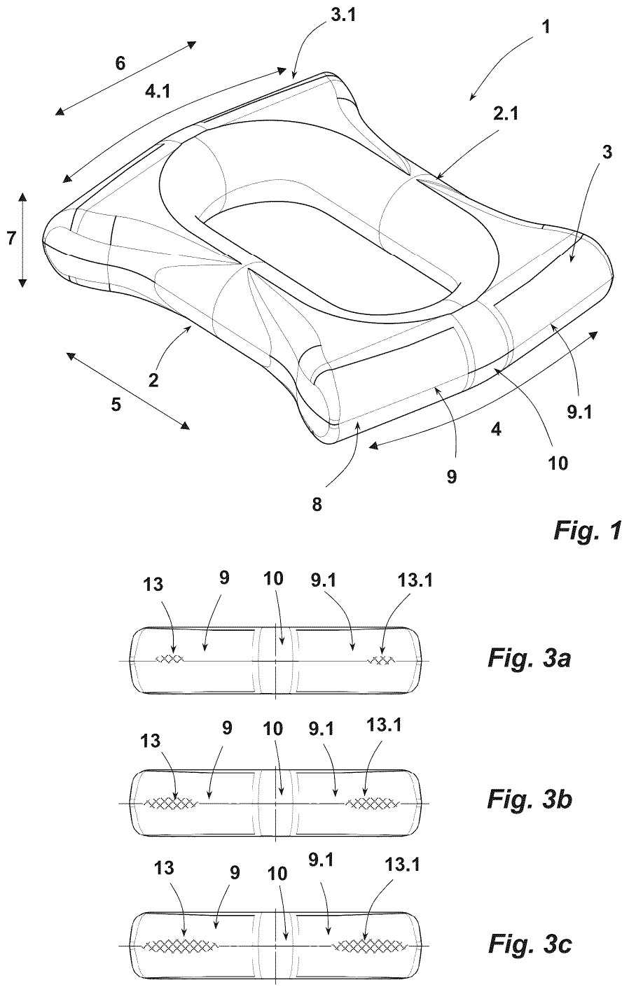

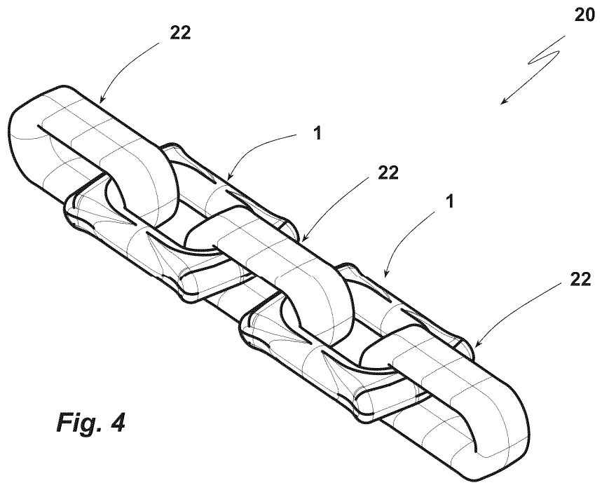

FIG. 1 shows a chain link 1 of a chain. A second chain link engages with the chain link 1 to form a chain. The chain link 1 shown in the figures is a horizontal chain link in this case; the chain link engaging with the chain link 1 is usually referred to as a vertical chain link. FIG. 4 shows an example chain 20 formed by first chain links 1 and second chain links 22.

The chain link 1 comprises two legs 2, 2.1, which are spaced apart and aligned parallel to one another. The two legs 2, 2.1 are designed symmetrically with respect to the longitudinal axis of the chain link 1.

The two legs 2, 2.1 are connected to one another by bows 3, 3.1 in the bow extension direction 4, 4.1. The bows 3, 3.1 are also each designed symmetrically with respect to the longitudinal axis of the chain link 1 and are also symmetrical with one another with respect to the transverse axis of the chain link 1.

The pitch direction 5 of the chain link 1 as well as its width direction 6 and height direction 7 are also shown in FIG. 1.

The end face 8 of the bow 3, which points outwards in the pitch direction 5 (the same applies to the opposite bow 3.1, but is not further referred to by reference symbols due to the symmetry, although all statements also apply to this bow 3.1) has two pressure portions 9, 9.1 spaced apart in the bow extension direction 4 and an intermediate portion 10 connecting the pressure portions 9, 9.1. The intermediate portion 10 directly adjoins the pressure portions 9, 9.1.

The pressure portions 9, 9.1 are curved in the bow extension direction 4, with a very large radius, which in this example embodiment is approximately 1,500 mm. This corresponds to approximately nine times the outer width of chain link 1.

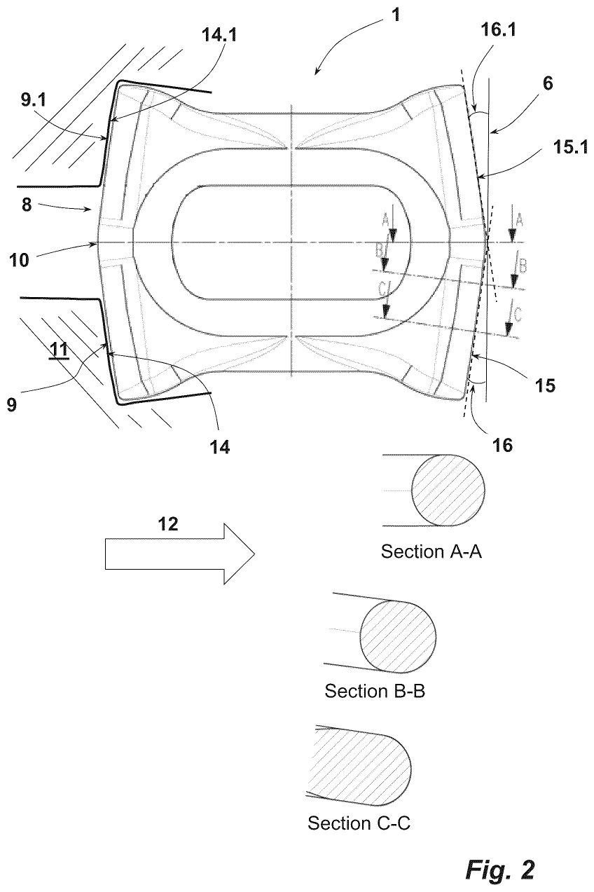

The intermediate portion 10 is also constantly curved with a radius in the bow extension direction 4, but has a smaller radius of curvature than the pressure portions 9, 9.1 and is therefore more strongly curved. This can also be seen in FIG. 2, which represents a top view of the chain link 1.

The end face 8 of the bow 3, which faces outwards in the pitch direction 5, is also curved transversely to the bow extension direction 4, and thus in the height direction 7. However, the curvature here is larger than in the bow extension direction 4 in the pressure portions 9, 9.1, and therefore the radius of curvature is smaller. This can also be clearly seen in FIG. 2 in detail sections A-A, B-B and C-C, showing the cross sections of the bow 3 along the sectional surfaces shown. The radius of curvature in the height direction 7 is constant, namely with a radius of half the height of the chain link 1.

The end face 8 of the chain link 1 thus designed provides contact surfaces 13, 13.1 in the pressure portions 9, 9.1, via which a compressive force is introduced into the bow 3 of the chain link 1, starting from a corresponding chain pocket 11 shown schematically in FIG. 2, so that a tensile force is introduced into the chain. For this purpose, the chain pocket 11 pushes the chain link 1 in a conveying direction 12.

Depending on the magnitude of the load between chain pocket 11 and chain link 1, a smaller or larger contact surface 13, 13.1 is provided by the curved pressure portions 9, 9.1. The contact surfaces 13, 13.1 are shown in cross-hatching in FIG. 3 for different load levels, wherein FIG. 3a represents a small load level, FIG. 3b represents a medium load level and FIG. 3c represents a strong load level. The greater the load, the larger the respective contact surface 13, 13.1. This is due to the deformation introduced by the load into the end face 8, i.e., into the pressure portions 9, 9.1. The elliptical dome-like design of the pressure portions 9, 9.1 is deformed at least in portions by the chain pocket 11, or drive portion 14, 14.1 on the chain pocket side, so that the pressure portions 9, 9.1 are in flat contact with the chain pocket drive portions 14, 14.1. The drive portion 14, 14.1 on the chain pocket side is usually also correspondingly deformed, but usually less than the pressure portion 9, 9.1 on the chain link side. The curvature of the pressure portions 9, 9.1, in particular in the bow extension direction 4, is so small or the radius of curvature is so large that even a small load-related deformation of the pressure portion 9, 9.1 results in a relatively large contact surface 13, 13.1, so that the surface pressure is reduced. The convex curvature in the bow extension direction 4 of the pressure portions 9, 9.1 also ensures that misalignment of the chain link 1 in the chain pocket 11 around the vertical axis is not a problem; although the contact surfaces 13, 13.1 may move over the respective pressure portions 9, 9.1 in the bow extension direction 4, the effect of the deformation-related flattening remains the same, so that the size of the contact surfaces 13, 13.1 does not change or does not change significantly under the same load, in particular not if the radius of curvature of the pressure portions 9, 9.1 is designed to be constant, as in this case.

The contact surfaces 13, 13.1 are aligned with the legs 2, 2.1. For this purpose, the bow 3 and the pressure portions 9, 9.1 are designed to be correspondingly wide, namely in this example embodiment extending beyond the outer width of the legs 2, 2.1. The chain pocket 11 is also designed accordingly. This results in a large surface introduction of force into the end face 8 of the bow 3. At the same time, the pressure portions 9, 9.1 in this region are relatively flat relative to the width direction 6 of the chain link 1, up to beyond the width of legs 2, 2.1.

For self-centering of the chain link 1 in the chain pocket 11, it is provided that the pressure portions 9, 9.1 are positioned relative to the width direction 6 of the chain link 1. The mean tangent 15, 15.1 of the pressure portions 9, 9.1 and the width direction 6 enclose an angle 16, 16.1 of approximately 8° in this example embodiment. This angle 16, 16.1 is larger than arctan (u), where u is the coefficient of friction in the region of the pressure portions 9, 9.1 of the chain link 1 and the drive portions 14, 14.1 of the chain pocket 11. By setting the pressure portions 9, 9.1 at a larger angle 16, 16.1 with respect to the width direction 6 than those just mentioned, the self-locking caused by friction is overcome.

At the same time, the angle of incidence 16, 16.1 is kept as flat as possible in order for the force to be introduced as straight as possible from the chain pocket 11 into the legs 2, 2.1, i.e., in the pulling direction of the chain.

In order to adjust the two pressure portions 9, 9.1 accordingly and still provide a large radius of curvature in the pressure portions 9, 9.1, the intermediate portion 10 has a smaller radius of curvature than that in the pressure portions 9, 9.1. The intermediate portion 10 extends here as a segment over the angular portion around which the pressure portions 9, 9.1 are essentially positioned (due to the curvature in the pressure portions 9, 9.1, slightly less than the angle between the mean tangents 15, 15.1 of pressure portions 9, 9.1 pointing in the pitch direction 5).

The invention has been described on the basis of one or more example embodiments. Without departing the scope of the claims, numerous further embodiments and options for implementing the invention are apparent to those skilled in the art, without these having to be explained or shown in greater detail in the context of this disclosure.

While several aspects and embodiments have been discussed herein, those persons skilled in the art will recognize numerous possible modifications, permutations, additions, combinations and sub-combinations therefor, without these needing to be specifically explained or shown within the context of this disclosure. The claims should therefore be interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE NUMERALS

1 chain link
2, 2.1 leg
3, 3.1 bow
4, 4.1 bow extension direction
5 pitch direction of the chain link
6 width direction of the chain link
7 height direction of the chain link
8 end face
9, 9.1 pressure portion
10 intermediate portion
11 chain pocket
12 direction of conveyance
13, 13.1 contact surface
14, 14.1 drive portion
15, 15.1 mean tangent
16, 16.1 angle between width direction and mean tangent
20 chain
22 second chain link

1. A chain comprising:
a chain link having two legs and two bows connecting the legs together via the bows extending in a bow extension direction between the two legs,
wherein an end face of at least one bow, which faces outwards in a pitch direction of the chain link, has two pressure portions spaced apart from one another in the bow extension direction and an intermediate portion connecting the pressure portions,
wherein the pressure portions each provide a contact surface between the chain link and a corresponding chain pocket of a chain wheel for introducing a force into the chain,
wherein the end face of the bow is convexly curved in the bow extension direction in the pressure portions and has, at least in portions in the intermediate portion, a smaller radius of curvature than in the pressure portions.

2. The chain of claim 1, wherein a mean tangent of curvature in the bow extension direction of each pressure portion forms an angle of 7° to 20° with a chain link width direction.

3. The chain of claim 1, wherein the pressure portions have a constant radius of curvature in the bow extension direction.

4. The chain of claim 1, wherein the intermediate portion has a constant radius of curvature in the bow extension direction.

5. The chain of claim 1, wherein the pressure portions are also convexly curved transversely to the bow extension direction.

6. The chain of claim 5, wherein each pressure portion has a constant curvature transversely to the bow extension direction.

7. The chain of claim 1, wherein the bow is designed to be rounded overall.

8. The chain of claim 1, wherein the pressure portions extend at least up to an outer width of the legs.

9. The chain of claim 1, wherein the chain link is a first chain link and the chain further comprises a second chain link engaging the first chain link, wherein the first chain link and/or the second chain link are designed such that the two chain links are prevented from kinking.

10. The chain of claim 9, wherein the legs of the first chain link are D-shaped in cross section such that a stop is provided at edges of the D shape, preventing the second chain link from diving into the first chain link when the second chain link envelopes one leg of the first chain link.

11. An arrangement comprising a chain according to claim 1 and a chain wheel, the chain wheel having at least one chain pocket corresponding to the chain link of the chain.

12. The arrangement of claim 11, wherein the chain pocket, in a region of the pressure portions of the chain link, has a larger radius of curvature in a chain link width direction than the pressure portions of the chain link.

13. The arrangement of claim 11, wherein, in normal operation, the contact surfaces provided by the pressure portions of the at least one bow of the first chain link are each limited to an alignment of a respective leg of the two legs adjoining the bow.
